(19) United States
(12) Patent Application Publication
(10) Pub. No.: US 2015/0238964 A1
(43) Pub. Date: Aug. 27, 2015

(54) MICROFLUIDIC APPARATUS AND MICROFLUIDIC SYSTEM INCLUDING THE SAME

(71) Applicant: SAMSUNG ELECTRONICS CO., LTD., Suwon-si (KR)

(72) Inventor: Yeong Bae YEO, Seoul (KR)

(73) Assignee: SAMSUNG ELECTRONICS CO., LTD., Suwon-si (KR)

(21) Appl. No.: 14/573,590

(22) Filed: Dec. 17, 2014

(30) Foreign Application Priority Data
Feb. 26, 2014 (KR) 10-2014-0022877

(51) Int. Cl. B01L 3/00

(52) U.S. Cl. CPC B01L 3/502753; B01L 3/502715; B01L 2300/0681; B01L 2300/0627; B01L 2300/0861; B01L 2300/14; B01L 2300/0803; B01L 2200/10

(57) ABSTRACT

A microfluidic apparatus and a microfluidic system including the same are provided. The microfluidic system includes a microfluidic apparatus including a platform, the platform including an inlet configured to receive a sample, a chamber configured to accommodate the sample received through the inlet, and a channel connecting the chamber to the inlet, a pressurizing apparatus configured to move the sample from the inlet to the chamber through the channel by pressurizing the inlet, and a detection apparatus configured to detect the sample inside of the chamber.

### CROSS-REFERENCE TO RELATED APPLICATION

This application claims priority from Korean Patent Application No. 10-2014-0022877, filed on Feb. 26, 2014 in the Korean Intellectual Property Office, the disclosure of which is incorporated herein by reference in its entirety.

### BACKGROUND

1. Field

Apparatuses and systems consistent with exemplary embodiments relate to a microfluidic apparatus and a microfluidic system including the same, and more particularly, a microfluidic apparatus having an improved structure capable of performing a centrifugal separation in a short period of time and ensuring durability, and a microfluidic system including the same.

2. Description of the Related Art

A microfluidic system is an apparatus configured to be used to perform a biological or chemical reaction by manipulating a small amount of sample.

The microfluidic system is appropriate to performs tests and is provided with various types of functions including sample separation, sample division, sample reaction, and sample detection.

In the related art, with respect to sample separation, a centrifugal chamber, which is configured to separate a sample by use of a centrifugal force on a platform referred to as a Lab-on-a-disc, is provided. According to such an apparatus, the centrifugal force and a driving force are to move a sample.

However, to secure the centrifugal force, the centrifugal chamber is needed to be extended toward a radial direction of the platform so that sample separation may take place. According to such a configuration, the diameter of the platform is needed to be large as necessary to be provided with the centrifugal chamber, and thus the size of the microfluidic apparatus is required to be large. In addition, a long time is needed to separate sample, and thus the amount of time required for testing is long.

### SUMMARY

One or more exemplary embodiments provide a microfluidic apparatus provided with an improved sample separation structure configured to separate a sample, to thereby achieve a miniaturization of the microfluidic apparatus and a capability of proceeding with a test in a short period of time, and a microfluidic system including the same.

In accordance with an aspect of an exemplary embodiment, there is provided a microfluidic system including a microfluidic apparatus including a platform, the platform including an inlet configured to receive a sample, a chamber configured to accommodate the sample received through the inlet, and a channel connecting the inlet to the chamber, a pressurizing apparatus configured to move the sample from the inlet to the chamber through the channel by pressurizing the inlet, and a detection apparatus configured to detect the sample inside of the chamber.

The platform may further include a filter provided at the inlet and configured to separate an analyte substance from the sample that is received through the inlet.

The chamber may include a testing chamber configured to accommodate the analyte substance that is filtered by the filter.

The testing chamber and the inlet may be provided at a central portion of the platform.

The chamber may include a detection chamber, and a distance between the chamber and a center portion of the platform is greater than a distance between the testing chamber and the center portion of the platform.

The pressurizing apparatus may include a pressurizing member configured to pressurize the inlet while making contact with the inlet, and a pressure driving motor configured to move the pressurizing member toward the inlet.

The microfluidic system may further include a driving apparatus configured to drive the microfluidic apparatus, and the driving apparatus may include a turntable configured to support the microfluidic apparatus, and a spindle motor configured to rotate the turntable.

The platform may further include a slip prevention member configured to be coupled to at least one portion of a surface of the microfluidic apparatus which contacts the turntable to prevent the microfluidic apparatus from slipping off the turntable.

The turntable may include a concave-convex unit having a portion which protrudes out from the turntable to mount the microfluidic apparatus on the turntable.

The detection apparatus may include a light source configured to radiate light to the chamber, and a light detector configured to detect the sample accommodated inside the chamber based on the light that is radiated through the chamber.

In accordance with another aspect of an exemplary embodiment, there is provided a microfluidic system including a platform, the platform including an inlet configured to receive a sample, a testing chamber connected to the inlet and configured to receive the sample through the inlet; a detection chamber configured to accommodate the sample, and a channel connecting the testing chamber to the detection chamber; and a pressurizing apparatus configured to pressurize the inlet to move the sample from the testing chamber to the detection chamber.

The microfluidic apparatus may further include a filter provided at the inlet to filter the sample that is received at the inlet.

The microfluidic system may further include a reagent provided in the detection chamber, and a detection apparatus configured to detect whether a subject substance is present in the sample based on a reaction between the reagent and an analyte substance of the sample that is transferred to the detection chamber.

In accordance with an aspect of another exemplary embodiment, there is provided a microfluidic apparatus including an inlet configured to receive a sample, a filter provided at the inlet and configured to separate the sample that is received through the inlet, a testing chamber configured to accommodate the sample that is filtered by the filter and divide the sample, detection chambers configured to accommodate the sample that is divided by the testing chamber, and channels connecting the testing chamber to the detection chambers, and through which the sample is moved.

The movement of the sample from the testing chamber to the detection chambers may be performed according to an external pressure that is applied to the filter.

The microfluidic apparatus may further include a platform in which the inlet, the testing chamber, the detection chambers and the channels are formed, and a guide unit protruding from a surface of the platform around the inlet, wherein the inlet may be provided at a central portion of the platform, and the filter may be inserted into the inlet.

The testing chamber may be provided at a side of the filter opposite the inlet, and a distance between the detection chambers and the central portion of the platform may be greater than a distance between the testing chamber and the central portion of the platform.

The detection chambers may be positioned on an identical circumference with respect to the central portion of the platform.

The detection chambers may be positioned on a plurality of circumferences that are different from each other with respect to the central portion of the platform.

The channels may independently extend from the testing chamber to respective detection chambers among the detection chambers.

The channels may include a first channel extending from the testing chamber, a second channel connected to the first channel, and third channels connected to the second channel and the detection chambers.

The platform may include an upper panel, a middle panel, and a lower panel, and the testing chamber may be formed at the upper panel and the middle panel.

The platform may include an upper panel and a lower panel, and the testing chamber may be formed by a concave-convex structure that is provided at the upper panel and the lower panel.

In addition, in accordance with an aspect of an exemplary embodiment, sample is separated by use of a filtering unit, and thus a centrifugal separation chamber is not needed to be separately provided.

### BRIEF DESCRIPTION OF THE DRAWINGS

The above and/or other aspects will become apparent and more readily appreciated from the following description of exemplary embodiments, taken in conjunction with the accompanying drawings of which:

FIG. 1 is a drawing illustrating a microfluidic apparatus in accordance with an exemplary embodiment;

FIG. 2 is an exploded view illustrating a platform of the microfluidic apparatus in accordance with an exemplary embodiment;

FIG. 3 is an exploded view illustrating a platform of a microfluidic apparatus in accordance with another exemplary embodiment;

FIG. 4 is an exploded view illustrating a platform of a microfluidic apparatus in accordance with still another exemplary embodiment;

FIG. 5 is an exploded view illustrating a platform of a microfluidic apparatus in accordance with still another exemplary embodiment;

FIG. 6 is a drawing schematically illustrating a microfluidic system in accordance with an exemplary embodiment;

FIG. 7A and FIG. 7B are drawings illustrating an operation of a pressurizing apparatus of the microfluidic system in accordance with an exemplary embodiment; and

FIG. 8 is a drawing illustrating one portion of a microfluidic system in accordance with another exemplary embodiment.

### DETAILED DESCRIPTION

Reference will now be made in detail to the exemplary embodiments, examples of which are illustrated in the accompanying drawings, wherein like reference numerals refer to like elements throughout.

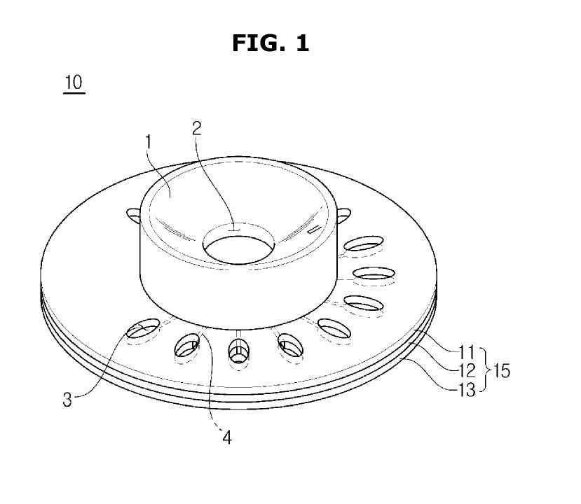

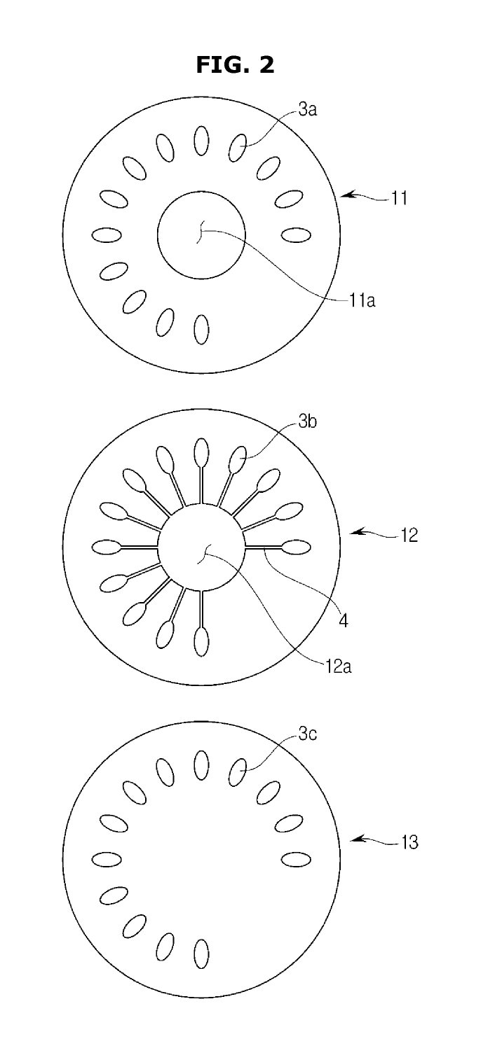

FIG. 1 is a drawing illustrating a microfluidic apparatus in accordance with an exemplary embodiment, and FIG. 2 is an exploded view illustrating a platform of the microfluidic apparatus in accordance with an exemplary embodiment.

As illustrated in FIG. 1 and FIG. 2, a microfluidic apparatus 10 includes a platform 15, at least one of a detection chamber 3 and a testing chamber 5 provided inside the platform 15 and in which a sample may be accommodated, and at least one channel 4 through which the sample may flow.

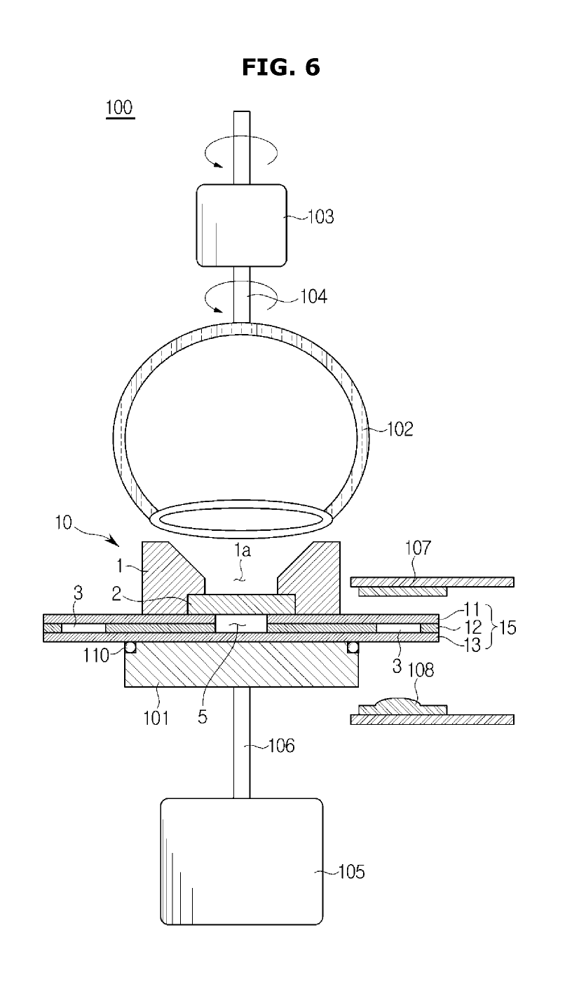

In accordance with an exemplary embodiment, the platform 15 may include an inlet 1a (see FIG. 6) through which the sample may be injected, a testing chamber 5 (see FIG. 6) to accommodate the sample that is filtered at the filtering unit 2, and a detection chamber 3 to accommodate the sample that is divided by the testing chamber 5. The microfluidic apparatus 10 may further include a filtering unit 2 (e.g., filter) to separate the sample that is injected through the inlet 1a.

The sample that may be analyzed by the microfluidic apparatus 10 of the present exemplary embodiment may include a bio sample such as blood, tissue liquid, bodily liquid having lymph liquid, saliva, and urine, or an environmental sample to be provided for the purpose of water quality control or soil management. However, in the exemplary embodiments, the type of the sample is not limited to the above-noted examples.

A guide unit 1 may be protrudedly provided toward an upper surface of the platform 15 at a circumference of the inlet 1a as to prevent the sample from being scattered to an outside the inlet 1a. The guide unit 1 is provided in a downwardly inclined manner toward the inlet 1a, and thus, in a case of when the sample is splashed at the guide unit 1, the sample may flow toward a direction of the inlet 1a to the filtering unit 2.

The filtering unit 2 configured to separate the sample may be inserted into the inlet 1a. In addition, the testing chamber 5 configured to accommodate the filtered sample may be positioned at a lower side of the filtering unit 2. The above exemplary configuration will be described later. The inlet 1a and the testing chamber 5 may be positioned at a central position of the platform 15.

In accordance with an exemplary embodiment, a distance between the detection chamber 3 and a center of the platform 15 is greater than a distance between the inlet 1a and the center of the platform 15. In addition, when a plurality of detection chambers 3 are provided, each detection chamber 3 may be positioned at an identical circumference of the platform 15. An analyte substance of the sample that is filtered at the filtering unit 2 may be transferred to the detection chamber 3 from the testing chamber 5 after passing through the channel 4 connecting the detection chamber 3 and the testing chamber 5. A reagent, which may react with respect to the analyte substance of the sample, may be accommodated in the detection chamber 3. According to the above exemplary configuration, the reaction between the analyte substance and the reagent may be detected through detection apparatuses 107 and 108 (FIG. 6). The above exemplary configuration will be described later.

The platform 15 may be provided in the shape of a rotatable disc, and the platform 15 may be able to be rotated while having a central axis of the platform 15 as a center. The chamber may be moved to a desirable position by the rotation of the platform 15.

The platform 15 may be manufactured by use of various materials, including glass, mica, silica, and silicon wafer, as well as plastic material that is convenient to be formed and that has a surface that is biologically inactive, such as acrylic, PDMS, PMMA, PC, polypropylene, polyvinyl alcohol, or polyethylene. However, the material of the platform 15 is limited hereto, and may be many different types of materials, as long as the material is provided with chemical and biological stability, optical transparency, and mechanical processability.

The platform 15 may be composed of several layers of panels. After creating an intaglio structure, which corresponds to the chamber or the channel, at a surface at which a certain one of the panels and another certain one of the panels meet each other, and then by adhesively joining the intaglio structure and the above panels, a space or a path may be provided at an inside of the platform 15. The adhesion of the above panels may be performed using various methods, including an adhesion method which uses an adhesive or a double-sided tape, an ultrasonic fusion method, and a laser welding method.

In accordance with an exemplary embodiment, the platform 15 may be composed of an upper panel 11, a middle panel 12, and a lower panel 13. Spaces 11a and 12a forming the testing chamber 5 may be provided at the upper panel 11 and the middle panel 12, respectively, and the testing chamber 5 is formed as the panels 11 and 12 are coupled to each other. A bottom surface of the testing chamber 5 is composed by the lower panel 13. Spaces 3a, 3b, and 3c forming the detection chamber 3 may be provided at the upper panel 11, the middle panel 12, and the lower panel 13, respectively. The detection chamber 3 is formed as the panels 11, 12 and 13 are coupled to each other. In a case of the upper panel 11 and the lower panel 13, spaces may be provided by forming an intaglio structure on the upper panel 11 and the lower panel 13 so as to form a top surface and a bottom surface of the detection chamber 3, while the upper surface and the bottom surface of the detection chamber 3 may be formed by attaching a separate sheet film.

In accordance with an exemplary embodiment, the channel 4 connecting the testing chamber 5 to the detection chamber 3 may be extendedly provided toward a radial direction on the platform 15. According to the above exemplary configuration, each channel 4 may be independently extended from the testing chamber 5 to the detection chambers 3. According to the above exemplary configuration, the analyte substance that is filtered at the filtering unit 2 may be transferred to each detection chamber 3 without interfering with each other. A top surface and a bottom surface of the channel 4 are formed by the upper panel 11 and the lower panel 13, respectively.

In addition, on at least one portion of the platform 15, a bar code (not shown) may be provided. As one example, the bar code (not shown) may be positioned at an upper surface or a side surface of the platform 15. The bar code (not shown) is capable of storing information, if needed, such as a manufacturing date or an expiration date of the microfluidic apparatus 10.

The bar code (not shown) may be a one-dimensional bar code. Alternatively, to store large amounts of information, various shapes of bar codes, for example, a matrix code, that is, a two-dimensional bar code, may be provided.

The bar code (not shown) may be replaced with a hologram, an RFID tag, or a memory chip each capable of storing information. In a case when a storage medium, such as a memory chip, as one example, in which information may be read and written, is provided in place of the bar code (not shown), the storage medium may store not only the information for purposes of identification, but may also store information with respect to patients, such as, for example, sample test results, time and date when blood is collected or when tests are administered, or whether tests are performed.

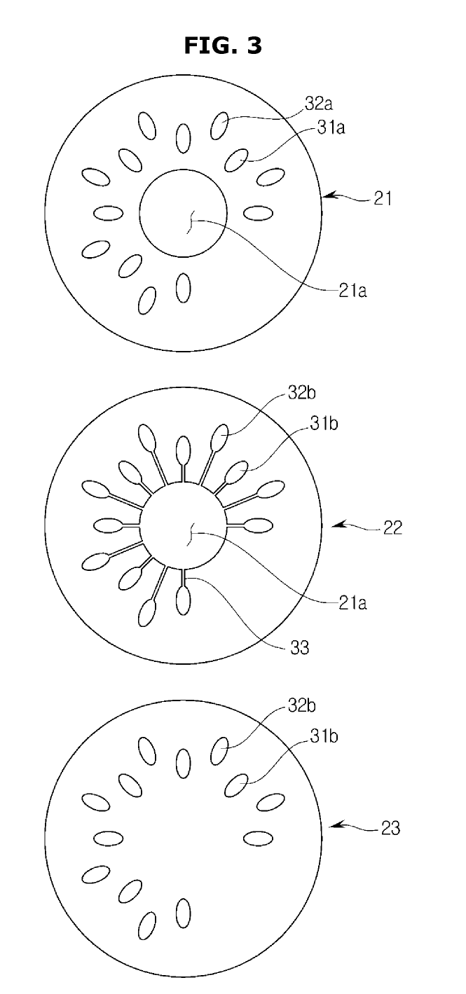

FIG. 3 is an exploded view illustrating a platform of a microfluidic apparatus in accordance with another exemplary embodiment.

As illustrated in FIG. 3, detection chambers 31 (including 31a and 31b) and 32 (including 32a and 32b) may be arranged to be positioned at a plurality of circumferences that are each different with respect to each other on the platform 15. That is, a distance between a first detection chamber 31 and a center of the platform 15 may be less than a distance between a second detection chamber 32 and the center of the platform 15, such that the first detection chamber 31 is positioned to be closer to a center of the platform 15 than the second detection chamber 32. According to the above exemplary configuration, the detection chambers 31 and 32 may be variably arranged at the platform 15, and the time at which the sample is moved from a testing chamber 21a to the detection chambers 31 and 32 may be able to be controlled according to the positions of the detection chambers 31 and 32. In addition, with respect to the detection of the analyte substance, the detection may take place by accommodating different analyte substances or reagents at each of the first detection chamber 31 and the second detection chamber 32.

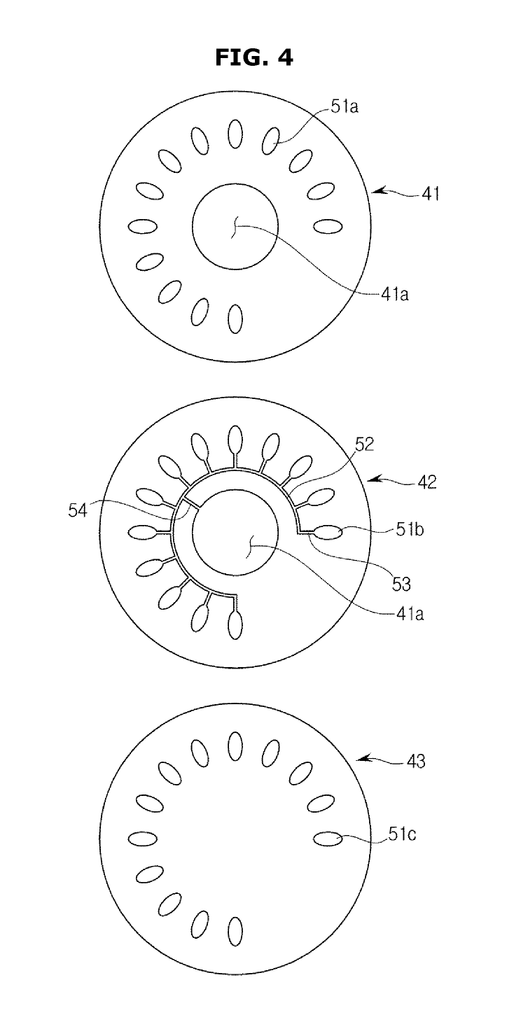

FIG. 4 is an exploded view illustrating a platform of a microfluidic apparatus in accordance with still another exemplary embodiment.

In accordance with the exemplary embodiment illustrated in FIG. 4, channels 52, 53, and 54 may include the first channel 54 extended from a testing chamber 41a, the second channel 52 communicating with the first channel 54, and third channels 53 communicating between the second channel 52 and detection chambers 51a, 51b, and 51c.

That is, a path through which the analyte substance may move from a testing chamber 41a may be the first channel 54 only. The first channel 54 may communicate with the third channel 53, which may be extended toward the detection chambers 51a, 51b and 51c, through the second channel 52. In accordance with an exemplary embodiment, the detection chambers 51a, 51b and 51c are arranged at an identical circumference of the platforms 41, 42, and 43, and the second channel 52 is provided to be extended toward a circumferential direction. The third channels 53 are each extended from one portion of the second channel 52 to respective ones of the detection chambers 51a, 51b, and 51c.

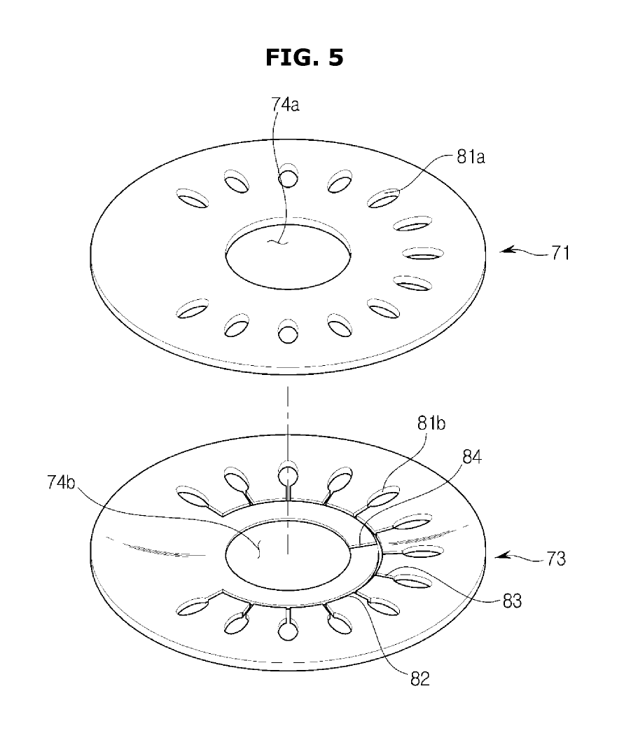

FIG. 5 is an exploded view illustrating a platform of a microfluidic apparatus in accordance with still another exemplary embodiment.

As illustrated in FIG. 5, platforms 71 and 73 may be implemented as an upper panel 71 and a lower panel 73, respectively. On at least at one portion of each of the upper panel 71 and the lower panel 73, a concave-convex structure may be formed, and the structure as such is configured to form a space in which chambers 74a, 74b, 81a, and 81b, and channels 82, 83, and 84 may be formed. In accordance with an exemplary embodiment, the space forming detection chambers 74a and 74b may be provided at the upper panel 71 and the lower panel 73. The space forming testing chambers 81a and 81b may be provided at the upper panel 71 and the lower panel 73. The space forming the channels 82, 83, and 84 may be provided at the lower panel 73.

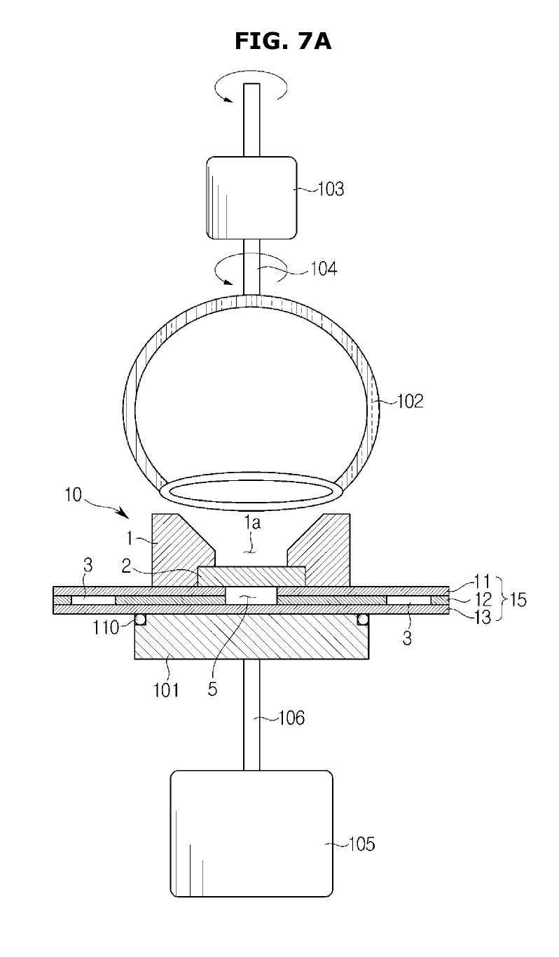

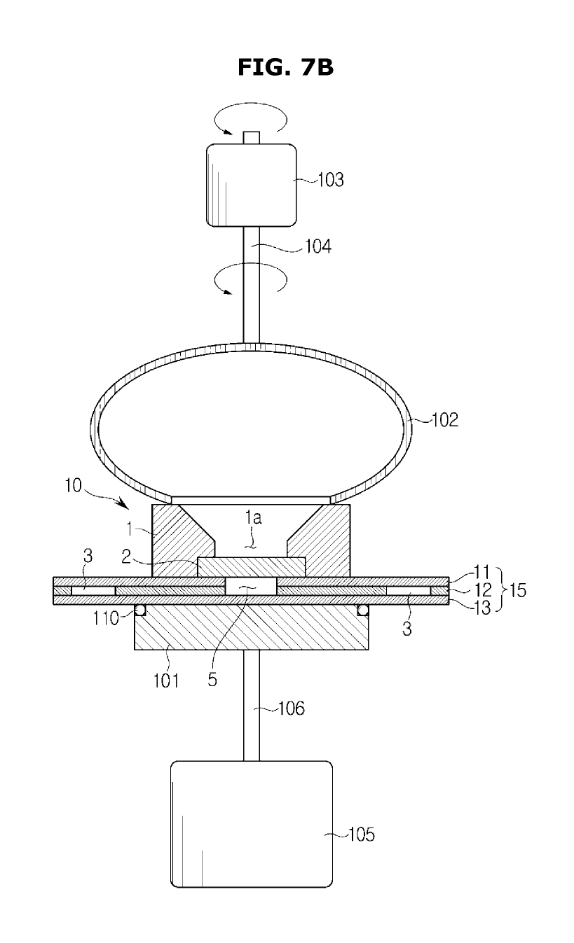

FIG. 6 is a drawing schematically illustrating a microfluidic system in accordance with an exemplary embodiment, and FIG. 7A and FIG. 7B are drawings illustrating an operation of a pressurizing apparatus of the microfluidic system in accordance with an exemplary embodiment.

As illustrated in FIG. 6 and FIG. 7, a microfluidic system 100 may include the microfluidic apparatus 10, pressurizing apparatuses 102, 103, and 104 configured to move an analyte substance of a sample to the detection and testing chambers 3 and 5 by pressurizing the inlet 1a, driving apparatuses 101, 105, and 106 configured to drive the microfluidic apparatus 10, and the detection apparatuses 107 and 108 configured to detect the sample inside the at least one of the chambers 3 and 5.

The detection and testing chambers 3 and 5, as described above, may be implemented as described above according to any of the exemplary embodiments.

The sample injected to the inlet 1a is filtered at the filtering unit 2 so as to filter the analyte substance. The filtering unit 2 may be insertedly coupled into a lower surface of the inlet 1a. The filtering unit 2 may include at least one multi-pore membrane having a plurality of pores so as to filter a substance, which is larger than a certain size inside the sample.

The filtering unit 2 may be formed of glass fiber, felt, absorbent filter, PC, PES, PE, PS, and PASF. In addition, a coating layer of functional substance having a particular function may be formed at a surface of the filtering unit 2. According to such a configuration, a particular substance from the sample may be combined or adsorbed with respect to the functional substance at the time of passing through the filtering unit 2, and thus, the particular substance may not pass through the filtering unit 2. Thus, the particular substance that is present in the sample may be filtered.

The filtering unit 2 may be provided with more than one layer. In a case when the filtering unit 2 is provided with a double layer, with respect to the sample that is passed through a first filtering unit, a filtering may be performed one more time at a second filtering unit. In addition, in a case when a large amount of large particles each having a larger size than the pore are introduced at once, a high-molecule membrane may be prevented from being torn or damaged. Each of the filtering units 2 may be processed by use of an adhesive substance (not shown) such as a double-sided adhesive.

The movement of the sample from the inlet 1a to the filtering unit 2 may be controlled through the pressurizing apparatuses 102, 103, and 104. The pressurizing apparatuses 102, 103, and 104 may include a pressurizing member 102 configured to apply pressure while in contact with the inlet 1a, and a pressure driving motor 103 configured to move the pressurizing member 102 toward a direction of the inlet 1a.

The pressurizing apparatus 102 may be provided with flexible material. As one example, the pressurizing apparatus 102 may be provided with silicon, urethane, or rubber material, but is not limited hereto, and may be provided with another type of material, such as another type of material which may have a shape which may be modified.

The pressure driving motor 103 is configured to press the pressurizing member 102 such that the pressurizing member 102 presses the inlet 1a. As the pressurizing member 102 is closely attached to the inlet 1a, the air pressure at an inside of the inlet 1a is increased, and thus the sample is passed through the filtering unit 2. As the analyte substance is collected at the testing chamber 5, the analyte substance is transferred to the detection chamber 3 by the pressure that is applied by the pressurizing member 102. However, the transferring of the analyte substance to the detection chamber 3 may also be performed by use of a centrifugal force that is generated while rotating the microfluidic apparatus 10.

The driving apparatuses 101, 105, and 106 may include a turntable 101 supporting the microfluidic apparatus 10, and a spindle motor 105 configured to rotate the turntable 101.

The spindle motor 105 is coupled to the turntable 101 by a rotational shaft 106. The turntable 101 is coupled to the platform 15 to rotate the platform 15.

In accordance with an exemplary embodiment, a slip prevention member 110 configured to prevent the microfluidic apparatus 10 from slipping off the turntable 101 may be coupled to at least one portion of a contact surface on which the turntable 101 makes contact with the microfluidic apparatus 10. According to an exemplary embodiment, the slip prevention member 110 is provided with rubber material, and may be coupled to the at least one portion of the turntable 101. In accordance with an exemplary embodiment, the slip prevention member 110 may be coupled to both end portions of the turntable 101, and may be able to prevent the microfluidic apparatus 10 from being separated from the turntable 101.

The detection apparatuses 107 and 108 may include a light source 107 configured to radiate light towards the at least one detection chamber 3, and a light detection unit 108 (e.g., light detector) configured to detect the analyte substance accommodated in the at least one of the detection chambers 3 according to the light that is passed through the at least one detection chamber 3. As the detection chamber 3 in which the analyte substance is accommodated is positioned in between the light source 107 and the light detection unit 108, the detection of the analyte substance may be performed.

The light source 107 is referred to as a light source configured to turn ON/OFF at a certain frequency, and a semiconductor light emitting terminal such as an LED (Light Emitting Diode) or an LD (Laser Diode), or a gas discharge lamp such as a halogen lamp or a xenon lamp is included.

The light detection unit 108 is configured to generate an electrical signal according to the strength of an incident light, and for example, a depletion layer photo diode, an APD (avalanche photo diode), or a PMT (photomultiplier tube) may be used.

The detection apparatuses 107 and 108 may be moved to the detection chamber 3 in which the analyte substance is accommodated. However, while the detection apparatuses 107 and 108 are in a fixed state, the platform 15 may be rotated as to position the detection chamber 3 in between the light source 107 and the light detection unit 108 as well.

According to the above exemplary configuration, in accordance with an exemplary embodiment, as the inlet 1a is pressured by the pressurizing member 102 so as to filter the sample through the filtering unit 2, a centrifugal separation chamber is not needed to be provided, and thus the size of the platform 15 may be miniaturized. In addition, as the plurality of detection chambers 3 is provided, various tests may be performed by accommodating different reagents in the each of the detection chambers 3.

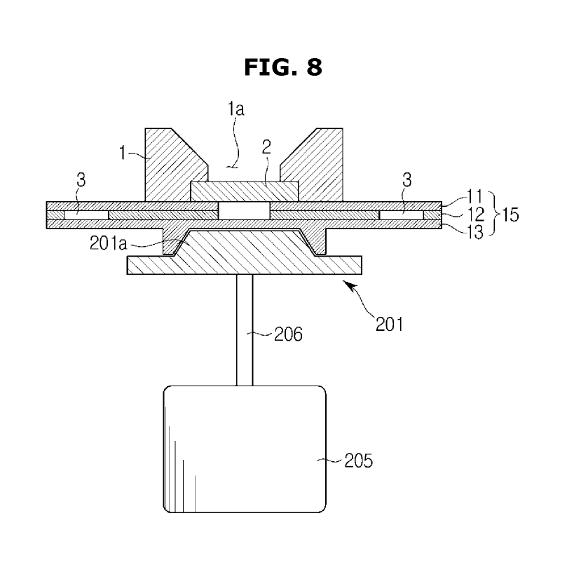

FIG. 8 is a drawing illustrating one portion of a microfluidic system in accordance with another exemplary embodiment.

As illustrated in FIG. 8, the turntable 201 may be provided on at least one portion thereof with a concave-convex structure 201a protruded such that the platform 15 may be mounted on the turntable 201. The concave-convex structure 201a is provided to correspond to the shape of a lower surface of the platform 15, and thus the platform 15 may be prevented from being separated from the turntable 201. In accordance with an exemplary embodiment, the concave-convex structure 201a may be provided as to correspond to the shape of the lower panel 13 of the platform 15.

Although a few exemplary embodiments have been shown and described, it would be appreciated by those skilled in the art that changes may be made in these exemplary embodiments without departing from the principles and spirit of the disclosure, the scope of which is defined in the claims and their equivalents.

What is claimed is:

1. A microfluidic system comprising:
a microfluidic apparatus comprising a platform, the platform comprising:
an inlet configured to receive a sample,
a chamber configured to accommodate the sample received through the inlet, and
a channel connecting the inlet to the chamber;
a pressurizing apparatus configured to move the sample from the inlet to the chamber through the channel by pressurizing the inlet; and
a detection apparatus configured to detect the sample inside of the chamber.

2. The microfluidic system of claim 1, wherein the microfluidic apparatus further comprises a filter provided at the inlet and configured to separate an analyte substance from the sample that is received through the inlet.

3. The microfluidic system of claim 2, wherein the chamber comprises a testing chamber configured to accommodate the analyte substance that is filtered by the filter.

4. The microfluidic system of claim 3, wherein the testing chamber and the inlet are provided at a central portion of the platform.

5. The microfluidic system of claim 3, wherein the chamber comprises a detection chamber, and a distance between the chamber and a center portion of the platform is greater than a distance between the testing chamber and the center portion of the platform.

6. The microfluidic system of claim 1, wherein the pressurizing apparatus comprises a pressurizing member configured to pressurize the inlet while making contact with the inlet, and a pressure driving motor configured to move the pressurizing member toward the inlet.

7. The microfluidic system of claim 1, further comprising a driving apparatus configured to drive the microfluidic apparatus,
wherein the driving apparatus comprises a turntable configured to support the microfluidic apparatus, and a spindle motor configured to rotate the turntable.

8. The microfluidic system of claim 7, wherein the driving apparatus further comprises a slip prevention member configured to be coupled to at least one portion of a surface of the microfluidic apparatus which contacts the turntable to prevent the microfluidic apparatus from slipping off the turntable.

9. The microfluidic system of claim 7, wherein the turntable comprises a concave-convex unit comprising a portion which protrudes out from the turntable to mount the microfluidic apparatus the turntable.

10. The microfluidic system of claim 1, wherein the detection apparatus comprises:
a light source configured to radiate light to the chamber, and
a light detector configured to detect the sample accommodated inside the chamber based on the light that is radiated through the chamber.

11. A microfluidic system comprising:
a microfluidic apparatus comprising a platform, the platform comprising:
an inlet configured to receive a sample,
a testing chamber connected to the inlet and configured to receive the sample through the inlet,
a detection chamber configured to accommodate the sample, and
a channel connecting the testing chamber to the detection chamber; and
a pressurizing apparatus configured to pressurize the inlet to move the sample from the testing chamber to the detection chamber.

12. The microfluidic system of claim 11, wherein the microfluidic apparatus further comprises a filter provided at the inlet to filter the sample that is received through the inlet.

13. The microfluidic system of claim 11, further comprising:
a reagent provided in the detection chamber; and
a detection apparatus configured to detect whether a subject substance is present in the sample based on a reaction between the reagent and an analyte substance of the sample that is transferred to the detection chamber.

14. A microfluidic apparatus comprising:
an inlet configured to receive a sample;
a filter provided at the inlet and configured to separate the sample that is received through the inlet;
a testing chamber configured to accommodate the sample that is filtered by the filter and divide the sample;
detection chambers configured to accommodate the sample that is divided by the testing chamber; and
channels connecting the testing chamber to the detection chambers, and through which the sample is moved.

15. The microfluidic apparatus of claim 14, wherein the movement of the sample from the testing chamber to the detection chambers is performed according to an external pressure that is applied to the filter.

16. The microfluidic apparatus of claim 14, wherein the microfluidic apparatus further comprises: a platform in which the inlet, the testing chamber, the detection chambers and the channels are formed; and
a guide unit protruding from a surface of the platform around the inlet, and
wherein the inlet is provided at a central portion of the platform, and the filter is inserted into the inlet.

17. The microfluidic apparatus of claim 16, wherein the testing chamber is provided at a side of the filter opposite the inlet, and a distance between the detection chambers and the central portion of the platform is greater than a distance between the testing chamber and the central portion of the platform.

18. The microfluidic apparatus of claim 17, wherein the detection chambers are positioned on an identical circumference with respect to the central portion of the platform.

19. The microfluidic apparatus of claim 17, wherein the detection chambers are positioned on a plurality of circumferences that are different from each other with respect to the central portion of the platform.

20. The microfluidic apparatus of claim 14, wherein the channels independently extend from the testing chamber to respective detection chambers among the detection chambers.

21. The microfluidic apparatus of claim 14, wherein the channels comprise a first channel extending from the testing chamber, a second channel connected to the second channel, and third channels connected to the second channel and the detection chambers.

22. The microfluidic apparatus of claim 14, wherein the platform comprises an upper panel, a middle panel, and a lower panel, and the testing chamber is formed at the upper panel and the middle panel.

23. The microfluidic apparatus of claim 14, wherein the platform comprises an upper panel and a lower panel, and the testing chamber is formed by a concave-convex structure that is provided at the upper panel and the lower panel.

24. A microfluidic system comprising:
a microfluidic device comprising:
a platform comprising an inlet configured to receive the sample and a detection chamber, and
a guide unit formed on a surface of the platform around the inlet, the guide unit being configured to guide a sample towards the inlet, and
a pressurizing apparatus configured to move the sample through the inlet towards the detection chamber by increasing air pressure in the guide unit.

25. The microfluidic system of claim 24, wherein the guide unit comprises protrusions formed around the inlet and configured to contact the pressurizing apparatus to form an airtight seal with the pressurizing apparatus.
